(19) United States
(12) Patent Application Publication
(10) Pub. No.: US 2008/0187387 A1
(43) Pub. Date: Aug. 7, 2008

(54) WEBBING APRON OF A DEVICE FOR WEBBING UP A PRINTING SUBSTRATE WEB IN A PRINTING PRESS

(75) Inventors: Hubert Ahle, Augsburg (DE); Gerhard Pichlmair, Neusaess (DE); Harald Feltl, Langweid (DE); Herbert Mayershofer, Augsburg (DE)

Correspondence Address: CROWELL & MORING LLP;INTELLECTUAL PROPERTY GROUP, P.O. BOX 14300, WASHINGTON, DC, 20044-4300, US

(73) Assignee: MAN Roland DruckmasChinen AG, Augsburg (DE)

(21) Appl. No.: 12/022,872

(22) Filed: Jan. 30, 2008

(30) Foreign Application Priority Data
Jan. 31, 2007 (DE) 10 2007 004 755.1

(51) Int. Cl. B41J 29/02; B23P 11/00

(52) U.S. Cl. 400/694; 29/428

(57) ABSTRACT

A webbing apron of a device for webbing up a printing substrate web in a printing press, namely a web-fed printing press, is disclosed. The webbing apron includes a cable, which is used for engagement of a tension element that is embodied in particular as a chain, and a flat element, where the flat element wraps around the cable at least in sections and is connected to the cable. The flat element is embodied of fluorinated rubber and the cable is permanently connected to the flat element made of fluorinated rubber by vulcanization.

This application claims the priority of German Patent Document No. 10 2007 004 755.1, filed Jan. 31, 2007, the disclosure of which is expressly incorporated by reference herein.

### BACKGROUND AND SUMMARY OF THE INVENTION

The invention relates to a webbing apron of a device for webbing up a printing substrate web in a printing press, namely a web-fed printing press.

A device for webbing up a printing substrate web is known from German Utility Model 92 15 764.5, which has a webbing apron fastened to a tension element that is embodied as a roller chain. The webbing apron has a cable, to which the roller chain can be connected via carriers. In addition, the webbing apron has a flat element, which wraps around the cable at least in sections, whereby the cable is connected to the flat element. According to this prior art, the flat element, which is connected to the cable, is embodied of a tear-resistance textile fabric, whereby the cable is connected to the flat element by adhesion, namely an adhesive strip.

When this webbing apron that is known from the prior art is moved by components of the printing press where high temperatures prevail, there is a danger of the connection between the cable and the flat element of the webbing apron detaching. As a result, there is a need for a webbing apron that is not sensitive to high temperatures.

Starting herefrom, the present invention is based on the objective of creating a novel webbing apron of a device for webbing up a printing substrate web in a printing press.

According to the invention, the flat element is embodied of fluorinated rubber, whereby the cable is permanently connected to the flat element made of fluorinated rubber by vulcanization.

In terms of the present invention, it is provided that the flat element be embodied of fluorinated rubber and that the cable be permanently connected to the flat element made of fluorinated rubber by vulcanization. This makes it possible to make an especially heat-resistant webbing apron available.

Preferred developments of the invention are yielded from the following description. Without being limited hereto, exemplary embodiments of the invention are explained in greater detail on the basis of the drawings.

### BRIEF DESCRIPTION OF THE DRAWINGS

FIG. 1 is a side view of an inventive webbing apron of a device for webbing up a printing substrate web in a printing press.

FIG. 2 is a detail of a portion of the webbing apron of FIG. 1 designated by reference character II.

FIG. 3 is a cross-section through the webbing apron along section line III-III in FIG. 2.

### DETAILED DESCRIPTION OF THE DRAWINGS

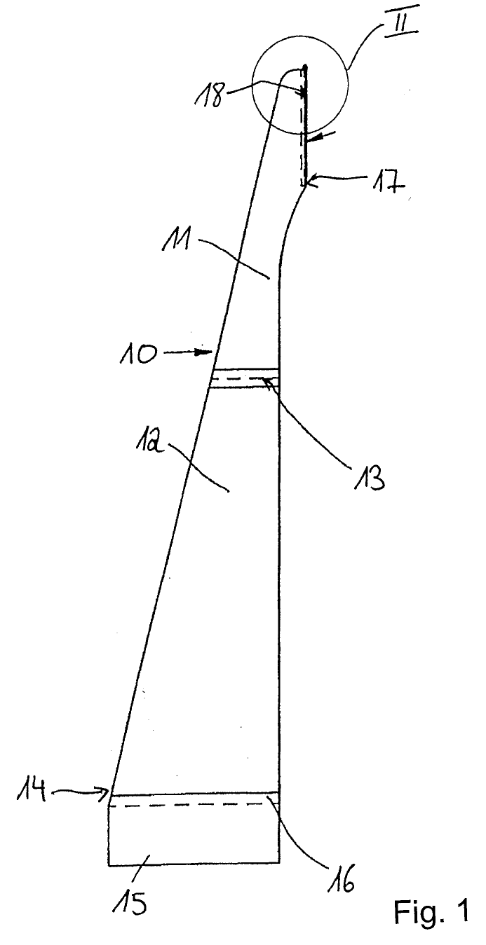

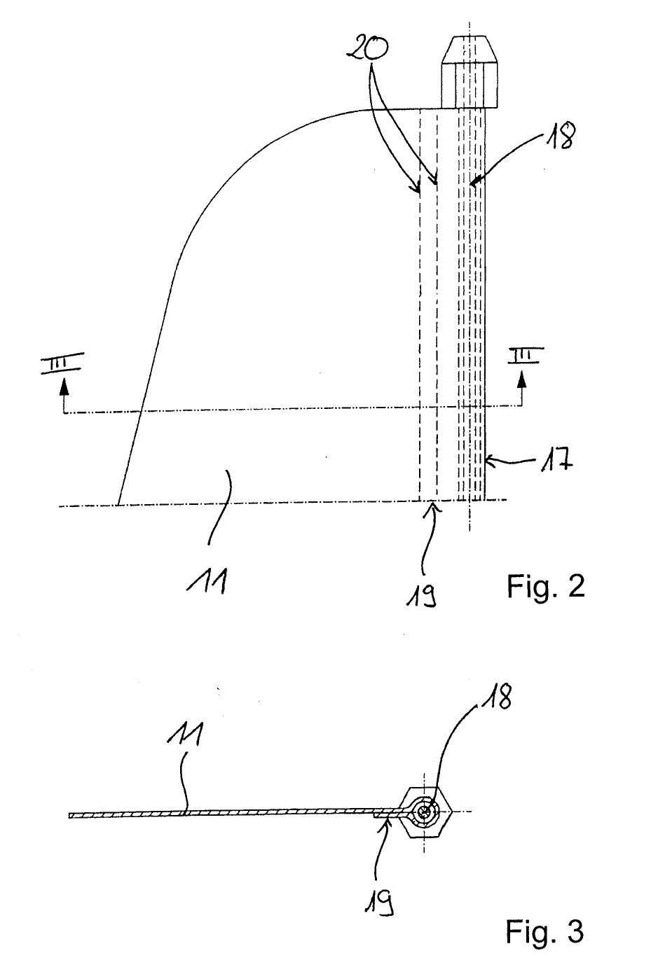

FIG. 1 shows a schematic representation of a webbing apron 10 of a device for webbing up a printing substrate web in a printing press. The webbing apron 10 is embodied essentially of two flat elements 11 and 12, which are connected to one another in a section 13. The connection of the two flat elements 11, 12 in section 13 is accomplished preferably by an adhesive strip.

The flat element 12 is used in particular to clasp the to-be-webbed-up printing substrate web, whereby to do so the flat element 12 has a pair of cover pieces 15 on one end 14, between which the to-be-webbed-up printing substrate web can be grasped. The two cover pieces 15 are comprised preferably of a magnetic film in order to clasp a to-be-webbed-up printing substrate web between the cover pieces 15 that are being magnetically attracted. The cover pieces 15 are in-turn connected to the end 14 of the flat element 12 using an adhesive strip 16.

The flat element 11 of the webbing apron 10 is used to attach the webbing apron 10 to a tension element that is embodied preferably as a roller chain. In this case, a cable 18 is allocated to one end 17 of the flat element 11. A tension element that is embodied preferably as a chain engages on the cable 18, e.g., in the manner that is known from German Utility Model 92 15 764.5.

In terms of the present invention, the flat element 11 of the webbing apron 10 is embodied of fluorinated rubber, in particular fluorinated hydrocarbon polymensate. The cable 18 is formed of at least one steel wire. The cable 18 is permanently connected to the flat element 11 made of fluorinated rubber by vulcanization. The combination of the material for the flat element 11 and the special connection between the flat element 11 and the cable 18 produces an especially heat-resistant webbing apron 10 in this section. As a result, there is no danger of the connection between the flat element 11 and the cable 18 of the webbing apron 10 detaching due to the effect of heat.

The flat element 11 made of fluorinated rubber wraps around the cable 18 at least in sections, thereby forming an overlapping area 19 of the flat element 11 as shown in FIG. 3. In this overlapping area 19, the overlapping sections of the flat element 11 are preferably sewed together via threads 20 of a heat-resistant yarn.

### LIST OF REFERENCE NUMERALS

10 Webbing apron
11 Flat element
12 Flat element
13 Section
14 End
15 Cover piece
16 Adhesive strip
17 End
18 Cable
19 Overlapping area
20 Thread

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. A webbing apron of a device for webbing up a printing substrate web in a printing press, namely a web-fed printing press, with a cable, which is used for engagement of a tension element that is embodied in particular as a chain, and with a flat element, wherein the flat element wraps around the cable at least in sections and is connected to the cable, wherein the flat element is embodied of fluorinated rubber and wherein the cable is permanently connected to the flat element made of fluorinated rubber by vulcanization.

2. The webbing apron according to claim 1, wherein the flat element is formed of fluorinated hydrocarbon polymensate.

3. The webbing apron according to claim 1, wherein the cable is formed of at least one steel wire.

4. The webbing apron according to claim 1, wherein an overlapping area of the flat element, which is formed by at least partial wrapping of the cable, is sewed with threads made of heat-resistant yarn.

5. A webbing apron of a device for webbing up a printing substrate web in a printing press, comprising:
a flat element, wherein the flat element is formed of fluorinated rubber; and
a cable;
wherein the flat element is vulcanized to the cable.

6. The webbing apron according to claim 5, wherein the flat element is wrapped around the cable.

7. The webbing apron according to claim 5, wherein the webbing apron further includes a second flat element and wherein the flat element is attached to the second flat element by an adhesive strip.

8. The webbing apron according to claim 7, wherein the webbing apron further includes a cover piece and wherein the cover piece is attached to the second flat element by a second adhesive strip.

9. A method of forming a webbing apron, comprising the steps of:
vulcanizing a flat element of the webbing apron to a cable of the webbing apron, wherein the flat element is formed of fluorinated rubber.

10. The method according to claim 9, further comprising the step of wrapping the flat element around the cable.

11. The method according to claim 10, further comprising the step of sewing a portion of the flat element wrapped around the cable with a heat resistant yarn.
